(19) United States
(12) Patent Application Publication
(10) Pub. No.: US 2007/0036112 A1
(43) Pub. Date: Feb. 15, 2007

(54) Method of determining next Transport Format Combination for being utilized in next Transmission Time Interval

(76) Inventor: Chien-Yi Chen, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/161,721

(22) Filed: Aug. 15, 2005

(51) Int. Cl. H04B 7/216

(52) U.S. Cl. 370/335; 370/342

(57) ABSTRACT

A method of determining a next TFC for being utilized by a UE in a next TTI is disclosed. The method includes: determining whether conditions for omitting a TFC selection procedure are met, applying a currently utilized TFC as the next TFC without performing the TFC selection procedure if the conditions for omitting the TFC selection procedure are met, and performing the TFC selection procedure to select a TFC out as the next TFC if at least one of the conditions for omitting the TFC selection procedure is not met.

### BACKGROUND

The present invention relates generally to Wideband Code Division Multiple Access (WCDMA) communication systems, and more particularly, to a method utilized by a Medium Access Control (MAC) sublayer of a user equipment (UE).

In many kinds of communication systems, both the device side and the network side are generally divided into a plurality of corresponding protocol layers. For example, in a WCDMA communication system, both a UE side and a network side comprise a Physical (PHY) layer (L1), a Data Link layer (L2), and a Network layer (L3). The Data Link layer (L2) is further split into several layers, including a Medium Access Control (MAC) sublayer and a Radio Link Control (RLC) sublayer. A plurality of transport channels (TrCHs) forms the interface between the PHY layer and the MAC layer, while a plurality of logical channels (LgCHs) forms the interface between the MAC layer and the RLC layer. The number of the TrCHs might be different from the number of the LgCHs. For uplink data transmission, the MAC layer needs to properly multiplex the LgCHs into the TrCHs.

A basic unit of data exchanged between the MAC layer and the PHY layer is called a Transport Block (TB). A set of TBs exchanged between the MAC layer and the PHY layer at the same time and through the same TrCH is called a Transport Block Set (TBS). A time period for TBS(s) to be exchanged through a TrCH is called a Transmission Time Interval (TTI) of the TrCH. Different TrCHs might have different TTIs, which could be either 10 ms, 20 ms, 40 ms, or 80 ms. For a given UE, the smallest value among the TTIs utilized by the TrCHs of the UE is called the shortest TTI, while the largest value among the TTIs utilized by the TrCHs of the UE is called the maximum TTI.

As shown in FIG. 1, for a given TrCH, a Transport Format Set (TFS) specifies the possible combinations of TB size (in bits) and TBS size (in number of blocks) that can be provided by the TrCH. The TFS includes multiple selectable Transport Formats (TFs), each defines a specification combination of TB size and TBS size, for the TrCH; each of the TFs is identified by a value called Transport Format Indicator (TFI). For example, for TrCH1, the possible TFs are 10×0, 10×2 and 10×4. When TFI is 0, the TF for TrCH1 would be 10×0, where 10 represents the TB size and 0 represents the TBS size. For uplink data transmission, the MAC layer of the UE should determine a TF for each of the TrCHs. However, a combination of TFs simultaneously utilized by all the TrCHs of the UE cannot be determined haphazardly; each combination of TFs being allowed for concurrently utilized by the TrCHs of the UE is referred to as a Transport Format Combination (TFC) of the UE. All the TFCs the UE is permitted to select are included in a list called Transport Format Combination Set (TFCS), which is assign by the network for bandwidth allocation. Basically, the reason to set up the TFCS is because the network generally limits the available bandwidth for each UE, and therefore is unable to satisfy all TFC of every transport channels. To prevent MAC layer from selecting a TFC that requires a bandwidth exceeding the available bandwidth, the list of TFCS limits the selection of each transport channel in MAC layer. For example, as shown in FIG. 2, according to the TFCS, for a specific TFC (identified by TFCI=0), the TFCS limits the selection of TFs for TrCH1, TrCH2 and TrCH3 as (10×0, 40×1, 80×1), meaning that the TF for TrCH1 is 10×0, the TF for TrCH2 is 40×1, and the TF for TrCH3 is 80×1. With the restriction of TFCS, when the TFC is selected, meaning that TFs of TrCH2 and TrCH3 are set to be 40×1 and 80×1, the TF of TrCH1 can only select 10×0.

In uplink data transmission, the MAC layer of the UE is responsible for an important function, called “TFC selection”, which including multiplexing the data from LgCHs to the TrCHs. For “every” imminent next TTI, considering the status of the LgCHs and the resources provided by the TrCHs, the MAC layer should select an appropriate TFC out from the TFCS for the next TTI, and the TFC selected out will be utilized in the next TTI. Conventionally, the TFC selection procedure needs to be performed in every shortest TTI since each transport channel might have different TTI. For example, if the shortest TTI for TrCH1, TrCH2 and TrCH3 is 10 ms, MAC layer needs to perform the TFC selection procedure in every 10 ms. The TFC selection procedure is quite an onerous and exhaustive procedure. Repeatedly performing the onerous and exhaustive TFC selection procedure will not only take up a considerable computation time, but also consume substantial system resources. It is therefore desired to have a simplified TFC selection procedure.

### SUMMARY OF THE INVENTION

According to an embodiment of the present invention, a method of determining a next TFC for being utilized by a UE in a next TTI is disclosed. The method includes determining whether conditions for omitting a TFC selection procedure are met, applying a currently utilized TFC as the next TFC without performing the TFC selection procedure if the conditions for omitting the TFC selection procedure are met, and performing the TFC selection procedure to select out a TFC as the next TFC if at lest one of the conditions for omitting the TFC selection procedure are not met.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an exemplary table illustrating TFSs of three TrCHs of a UE.

FIG. 2 shows an exemplary table illustrating TFCS of the UE.

FIG. 3 shows an exemplary flowchart illustrating the method of the present invention.

FIG. 4 shows an exemplary flowchart illustrating the method of FIG. 3 in more detail.

### DETAILED DESCRIPTION

For a UE in a WCDMA communication system, the method of the present invention omits the TFC selection procedure when some specific conditions are met, so as to reduce the time required for performing the TFC selection procedure.

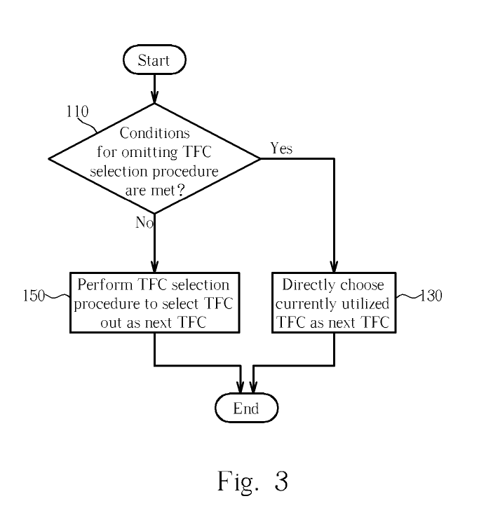

FIG. 3 shows an exemplary flowchart illustrating the method of the present invention. Briefly speaking, in the TFC selection procedure, for determining a next TFC for being utilized in a next TTI, the UE (more specifically, the MAC layer of the UE) firstly determines whether conditions for omitting the TFC selection procedure are met or not (step 110). If the conditions for omitting the TFC selection procedure are met, the MAC layer directly chooses a currently utilized TFC as the next TFC (step 130) without performing the TFC selection procedure. The currently utilized TFC is a TFC utilized in a current TTI. If at least one of the conditions for omitting the TFC selection procedure is not met, the TFC selection procedure will be performed so as to select out a TFC as the next TFC (step 150).

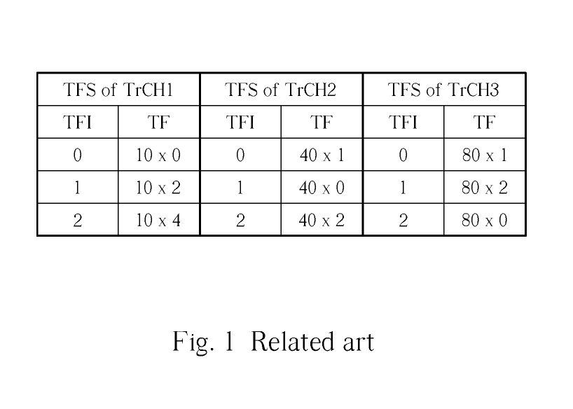

In the exemplary flowchart shown in FIG. 1, the conditions for omitting the TFC selection procedure may comprise several specific conditions, such as “an allowable TFC subset for the next TTI is the same as an allowable TFC subset for the current TTI” and “no logical channel of the UE has influential change in data amount”. For example, if the allowable TFC subset for the next TTI comprises a TFC that is not included in the allowable TFC subset for the current TTI, or the currently utilized TFC is not included in the allowable TFC subset for the next TTI, it is determined that the allowable TFC subset for the next TTI is different from the allowable TFC subset for the current TTI, and one condition for omitting the TFC selection procedure is not met.

There are some reasons that cause the allowable TFC subset to be changed and the allowable TFC subset for the next TTI has therefore become different from the allowable TFC subset for the current TTI. A TFC control message is one of the reasons that cause the allowable TFC subset to be changed. For example, when a congestion situation occurs, the network side may send a TFC control message to the UE. According to this TFC control message, some TFCs might be temporarily removed from the allowable TFC subset. Similarly, after the congestion situation is resolved, the network side may send another TFC control message to the UE. According to this TFC control message, the previously removed TFCs might be added back to the allowable TFC subset. Both these two situations may cause the allowable TFC subset to be changed.

In addition, an essential feature in the WCDMA communication system is uplink power control. The network side monitors the UE transmission power to make sure that the received power level is under an acceptable power limit. If the UE transmission power is higher than the acceptable power limit expected by the network side, the power received by the network side might become an extra-interference for other users. Hence, for uplink power control, the network side might send a transmission power adjustment request including the acceptable power limit to the UE. With the acceptable power limit, some TFCs might be removed from the allowable TFC subset if their required power is over the acceptable power limit. Generally speaking, a TFC providing a higher overall data throughput to the MAC layer consumes more power than another TFC providing a lower overall data throughput to the MAC layer. Hence, if the required power of the current TFC exceeds the acceptable power limit in the next TTI, it cannot be used as the next TFC and a TFC selection procedure should be performed. Consequently, transmission power adjustment requests received from the network side constitute another reason that causes the allowable TFC subset to be changed.

Therefore, the MAC layer of the UE may examine whether a TFC control message or a transmission power adjustment request is received by the UE or not, to determine if the allowable TFC subset is changed or not. If the UE has received a TFC control message that makes the allowable TFC subset for the next TTI be different from the allowable TFC subset for the current TTI, it is determined that one of the conditions for omitting the TFC selection procedure is not met. Similarly, if the UE has received a transmission power adjustment request that makes the allowable TFC subset for the next TTI be different from the allowable TFC subset for the current TTI, it is determined that one of the conditions for omitting the TFC selection procedure is not met.

As mentioned, another condition for omitting the TFC selection procedure is that “no logical channel of the UE has influential change in data amount”. Generally speaking, the MAC layer performs the TFC selection procedure with reference to data amounts of the LgCHs of the UE. If no LgCH of the UE has influential change in data amount, the currently utilized TFC will still be suitable for the UE in the next TTI; even more, the currently utilized TFC may still be an optimal one for the next TTI. Therefore, under this circumstance omitting the TFC selection procedure becomes feasible and the MAC layer can directly choose the currently utilized TFC as the next TFC.

For a given LgCH, if the data amount of the LgCH remains unchanged, obviously, it will be concluded that the data amount of the LgCH has no “influential change”. Even if the data amount of the LgCH is changed, as long as the change in the data amount of the LgCH does not induce the currently utilized TFC to become an unsuitable one, a conclusion that the data amount of the LgCH has no “influential change” will still be made. For example, when the data amount of the logical channel is increased but no other TFC in the allowable TFC subset for the next TTI can provide more data throughput to the logical channel than the currently utilized TFC, it is still concluded that the data amount of the logical channel has no influential change. Similarly, when the data amount of the logical channel is decreased but the decreased data amount of the logical channel is still larger than the data throughput provided to the logical channel by the currently utilized TFC, it is still concluded that the data amount of the logical channel has no influential change.

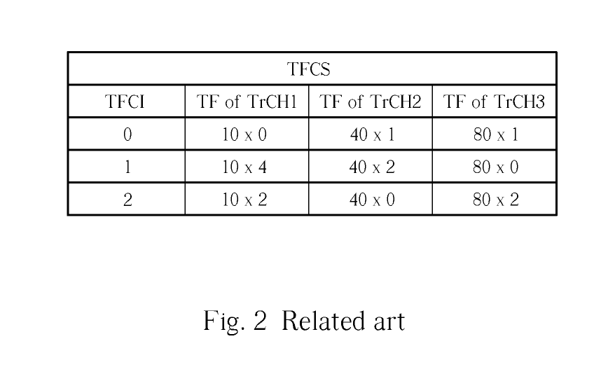

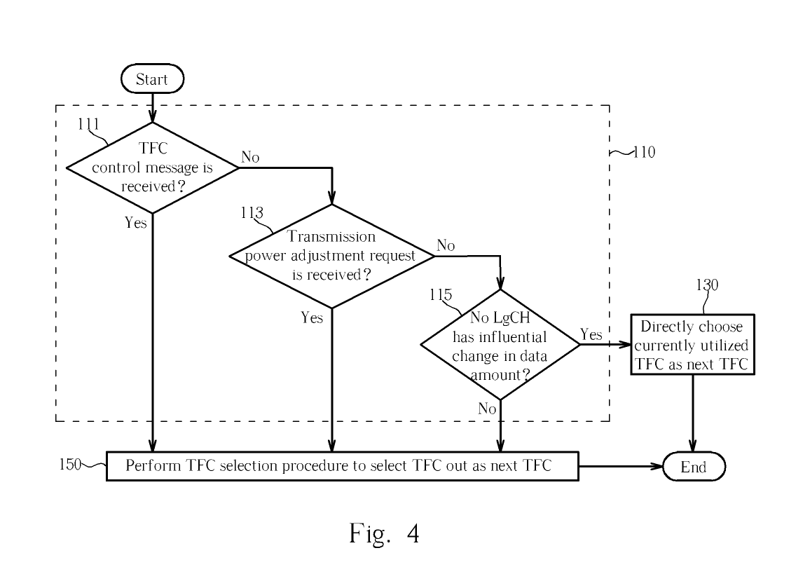

FIG. 4 shows an exemplary flowchart illustrating the method of FIG. 3 in more detail. In step 111 of this exemplary flowchart, the MAC layer determines whether a TFC control message that makes the allowable TFC subset for the next TTI be different from the allowable TFC subset for the current TTI is received or not. If the TFC control message is received, it means that the TFC selection procedure is unavoidable and step 150 will be performed; otherwise, step 113 will be performed. In step 113, the MAC layer determines whether a transmission power adjustment request that makes the allowable TFC subset for the next TTI be different from the allowable TFC subset for the current TTI is received or not. If the transmission power adjustment request is received, it means that the TFC selection procedure is unavoidable and step 150 will be performed; otherwise, step 115 will be performed. In step 115, the MAC layer examines whether each LgCH of the UE has no influential change in data amount. If none of the LgCHs of the UE has influential change in data amount, step 130 will be performed; otherwise, step 150 will be performed. As mentioned, step 130 is performed only when the conditions for omitting the TFC selection procedure are met. The MAC layer directly chooses the currently utilized TFC as the next TFC in step 130. Step 150 is performed when at least one of the conditions for omitting the TFC selection procedure is not met. The MAC layer performs the TFC selection procedure to select out a TFC from the allowable TFC subset for the next TTI as the next TFC in step 150. Please note that the sequence of performing steps 111, 113 and 115 as shown in FIG. 2 serves only as an example. A system designer can also choose another sequence to perform the mentioned steps 111, 113 and 115.

With the idea of omitting the TFC selection procedure when the conditions are met, considerable computation time and system resources can be conserved. In addition, it is well-known that the UE is a device providing circuit switch (CS) domain services and packet switch (PS) domain services. For a CS domain service, the required data size and number of the CS domain service are substantially constant. Therefore LgCHs providing CS domain services generally have no influential change in data amount. In this case, the step 115 could be omitted.

As for the PS domain services, by executing the step 115, it is not difficult to meet the conditions for omitting the TFC selection procedure. In the PS domain service, the required data size and number changes drastically only when data transmission is initiated and when data transmission is terminated. For most of the time, the required data size and number of the PS domain service remain zero or fixed value. Therefore, it is highly probable that LgCHs providing PS domain services do not have influential change in data amount in several consecutive TTIs. When the conditions for omitting the TFC selection procedure are met, according to the method of the present invention, the UE can directly choose a currently utilized TFC as a next TFC without performing the onerous and exhaustive TFC selection procedure. Considerable computation time and substantially system resources are therefore conserved.

Those skilled in the art will readily observe that numerous modifications and alterations of the method may be made while retaining the teachings of the invention. Accordingly, the above disclosure should be construed as limited only by the metes and bounds of the appended claims.

What is claimed is:

1. A method of determining a next transport format combination (TFC) for being utilized by a user equipment (UE) in a next transmission time interval (TTI), the method comprising:
determining whether conditions for omitting a TFC selection procedure are met;
applying a currently utilized TFC as the next TFC without performing the TFC selection procedure if the conditions for omitting the TFC selection procedure are met; and
performing the TFC selection procedure to select a TFC out as the next TFC if at least one of the conditions for omitting the TFC selection procedure is not met.

2. The method of claim 1, wherein if an allowable TFC subset for the next TTI comprises a TFC that is not included in an allowable TFC subset for a current TTI, or the currently utilized TFC is not included in the allowable TFC subset for the next TTI, it is determined that one of the conditions for omitting the TFC selection procedure is not met.

3. The method of claim 1, wherein the step of determining whether the conditions for omitting the TFC selection procedure are met comprises:
determining whether an allowable TFC subset for the next TTI is the same as an allowable TFC subset for a current TTI.

4. The method of claim 1, wherein if the UE receives a TFC control message that forbids using the currently utilized TFC in the next TTI, it is determined that one of the conditions for omitting the TFC selection procedure is not met.

5. The method of claim 1, wherein a transmission power limit is provided to the UE, if the required power of the currently utilized TFC exceeds the transmission power limit, it is determined that one of the conditions for omitting the TFC selection procedure is not met.

6. The method of claim 1, wherein the step of determining whether the conditions for omitting the TFC selection procedure are met comprises:
determining whether data amount of each logical channel of the UE has no influential change.

7. The method of claim 6, wherein for a logical channel of the UE, if the data amount of the logical channel is increased but no other TFC in an allowable TFC subset for the next TFC can provide more data throughput to the logical channel than the currently utilized TFC, or the data amount of the logical channel is decreased but is still larger than the data throughput provided to the logical channel by the currently utilized TFC, the data amount of the logical channel is determined to have no influential change; otherwise, the data amount of the logical channel is determined to have influential change.

8. A transport format combination (TFC) selection method applicable to a mobile unit in a communication system, wherein the mobile unit utilizes a first TFC until a next transmission time interval (TTI), the method comprising:
providing a TFC selection procedure;
providing at least one condition for omitting the TFC selection procedure;
determining whether the conditions for omitting the TFC selection procedure are met; and
keeping utilizing the first TFC during the next TTI without performing the TFC selection procedure if the conditions for omitting the TFC selection procedure are met.

9. The method of claim 8, further comprising:
performing the TFC selection procedure to select a TFC for utilizing during the next TTI if at least one of the conditions for omitting the TFC selection procedure is not met.

10. The method of claim 8, further comprising:
providing a first allowable TFC subset for utilizing before the next TTI and a second allowable TFC subset for utilizing during the next TTI, wherein the step of determining whether the conditions for omitting the TFC selection procedure are met comprises:
determining whether the second allowable TFC subset comprises any TFC that is not included in the first allowable TFC subset, or the first TFC is not included in the second allowable TFC subset;
wherein, if the second allowable TFC subset comprises any TFC that is not included in the first allowable TFC subset, or the first TFC is not included in the second allowable TFC subset, it is determined that one of the conditions for omitting the TFC selection procedure is not met.

11. The method of claim 8, wherein the step of determining whether the conditions for omitting the TFC selection procedure are met comprises:
determining whether the mobile unit receives a TFC control message from the communication system that forbids using the first TFC in the next TTI;
wherein if the mobile unit receives the TFC control message, it is determined that one of the conditions for omitting the TFC selection procedure is not met.

12. The method of claim 8, wherein the step of determining whether the conditions for omitting the TFC selection procedure are met comprises:
providing a transmission power limit; and
determining whether the required power of the first TFC exceeds the transmission power limit;
wherein, if the required power of the first TFC exceeds the transmission power limit, it is determined that one of the conditions for omitting the TFC selection procedure is not met.

13. The method of claim 8, wherein the step of determining whether the conditions for omitting the TFC selection procedure are met comprises:
determining whether data amount of each logical channel of the mobile unit has no influential change.

14. The method of claim 13, wherein if the data amount of a logical channel of the mobile unit is increased but no other TFC in an allowable TFC subset can provide more data throughput to the logical channel than the first TFC, or the data amount of the logical channel is decreased but is still larger than the data throughput provided to the logical channel by the first TFC, the data amount of the logical channel is determined to have no influential change; otherwise, the data amount of the logical channel is determined to have influential change.

15. The method of claim 8, wherein the communication system is a WCDMA communication system.

16. A transport format combination (TFC) selection system applicable to a mobile unit in a communication system, wherein the mobile unit utilizes a first TFC until a next transmission time interval (TTI), the system comprising:
a detector for determining whether conditions for omitting the TFC selection procedure are met; and
a TFC selection procedure module, coupled to the detector, for performing a predetermined TFC selection procedure to select a TFC for utilizing during the next TTI if at least one of the conditions for omitting the TFC selection procedure is not met, and for keeping utilizing the first TFC during the next TTI without performing the TFC selection procedure when the conditions for omitting the TFC selection procedure are met.

17. The system of claim 16, further comprising:
a database, coupled to the detector, for storing a first allowable TFC subset for utilizing before the next TTI and a second allowable TFC subset for utilizing during the next TTI, wherein the detector determines whether the second allowable TFC subset comprises any TFC that is not included in the first allowable TFC subset, or the first TFC is not included in the second allowable TFC subset, wherein if the second allowable TFC subset comprises any TFC that is not included in the first allowable TFC subset, or the first TFC is not included in the second allowable TFC subset, the detector determines that one of the conditions for omitting the TFC selection procedure is not met.

18. The system of claim 16, wherein the detector determines whether the mobile unit receives a TFC control message from the communication system that forbids using the first TFC in the next TTI, wherein if the mobile unit receives the TFC control message, the detector determines that one of the conditions for omitting the TFC selection procedure is not met.

19. The system of claim 16, wherein the detector determines whether the required power of the first TFC exceeds a transmission power limit; wherein if the required power of the first TFC exceeds the transmission power limit, the detector determines that one of the conditions for omitting the TFC selection procedure is not met.

20. The system of claim 16, wherein the detector determines whether data amount of each logical channel of the mobile unit has no influential change.

21. The system of claim 20, wherein if the data amount of a logical channel of the mobile unit is increased but no other TFC in an allowable TFC subset can provide more data throughput to the logical channel than the first TFC, or the data amount of the logical channel is decreased but is still larger than the data throughput provided to the logical channel by the first TFC, the data amount of the logical channel is determined to have no influential change; otherwise, the data amount of the logical channel is determined to have influential change.

22. The system of claim 16, wherein the communication system is a WCDMA communication system.
